(19) United States
(12) Patent Application Publication
(10) Pub. No.: US 2025/0035172 A1
(43) Pub. Date: Jan. 30, 2025

(54) DISC BRAKE DEVICE

(71) Applicant: NIPPON STEEL CORPORATION, Tokyo (JP)

(72) Inventors: Ayumi UENISHI, Chiyoda-ku, Tokyo (JP); Takahiro FUJIMOTO, Chiyoda-ku, Tokyo (JP); Hiroshi NOGAMI, Chiyoda-ku, Tokyo (JP); Mitsuhiro OKAMOTO, Chiyoda-ku, Tokyo (JP); Naruo MIYABE, Chiyoda-ku, Tokyo (JP); Yuki ICHIKAWA, Chiyoda-ku, Tokyo (JP); Takanori KATO, Chiyoda-ku, Tokyo (JP); Ryuichi NISHIMURA, Chiyoda-ku, Tokyo (JP); Yuiko SHIOTANI, Chiyoda-ku, Tokyo (JP)

(21) Appl. No.: 18/716,213

(22) PCT Filed: Oct. 31, 2022
(86) PCT No.: PCT/JP2022/040589

§ 371 Date: Jun. 4, 2024

(30) Foreign Application Priority Data
Dec. 28, 2021 (JP) 2021-213910

(51) Int. Cl. F16D 65/00; B61H 5/00; F16D 65/847

(52) U.S. Cl. CPC F16D 65/0006; B61H 5/00; F16D 65/847

(57) ABSTRACT

A disc brake device includes a rotary member, a brake disc, and an airflow-rate restriction member. The brake disc includes a disc body and a plurality of fins. The airflow-rate restriction member includes a base plate and a protruding portion. The base plate is sandwiched between the rotary member and the fins. The protruding portion is arranged inward in the radial direction of the disc body with respect to the fins. The protruding portion protrudes from the base plate toward a disc body side. The protruding portion extends in the circumferential direction of the disc body.

### TECHNICAL FIELD

The present disclosure relates to a disc brake device for a railway vehicle.

### BACKGROUND ART

Disc brake devices are widely in use as a braking device for a railway vehicle. Such a disc brake device includes an annular brake disc and a brake lining. For example, the brake disc is fastened to a wheel of the railway vehicle and rotates with the wheel. A brake lining is to be pressed against the brake disc. Friction between the brake lining and the brake disc decelerates the railway vehicle.

Sufficient cooling performance is required for the brake disc of the disc brake device from the viewpoint of ensuring durability of the brake disc. To ensure cooling performance during braking, a plurality of fins are commonly provided on a back surface of the brake disc in a radial formation. The brake disc is fastened to the wheel while the fins are in contact with the wheel, so that a ventilation passage surrounded by adjacent fins, the brake disc, and the wheel is formed. When the brake disc rotates with the wheel, the ventilation passage allows air to pass therethrough from an inner circumferential side to an outer circumferential side of the brake disc. The air flowing through the ventilation passage cools the brake disc.

However, while the railway vehicle is travelling, due to the air flowing in the ventilation passage between the brake disc and the wheel, aerodynamic sound is generated. In particular, when the railway vehicle is travelling at high speed, the airflow rate in the ventilation passage increases to generate louder aerodynamic sound.

To address this, Patent Literature 1 discloses a disc brake device in which fins that are adjacent to each other in a circumferential direction are connected by a connecting portion. In this disc brake device, a portion which is the smallest in its sectional area is formed in each ventilation passage between the fins by the connecting portion. According to Patent Literature 1, by making a total sum of the smallest sectional areas of the ventilation passages 18000 mm² or less, the aerodynamic sound can be reduced during high-speed travelling.

In Patent Literature 1, the connecting portion for reducing the aerodynamic sound is formed integrally with the brake disc. Accordingly, in the brake disc, the rigidity of a portion near the connecting portion is larger than those of other portions. Accordingly, when the brake lining slides on the brake disc and frictional heat is generated during braking, the portion near the connecting portion is less susceptible to heat deformation than other portions, leading to a warpage in the brake disc. As a result, a load on the fastening member that fastens the brake disc to the wheel may increase.

In Patent Literature 1, because of the connecting portion being integrated with the brake disc body and the fins, design freedom for the disc body or the fins may be reduced. For example, when the brake disc is produced by forging, yield of the brake disc may decrease due to difficulty in forming the connecting portion.

To address this, Patent Literature 2 proposes a technique of providing an aerodynamic-sound reduction member that is separate from the brake disc for the disc brake device. The aerodynamic-sound reduction member includes a plate-shaped support portion and a plurality of protruding portions that protrude from the support portion. According to Patent Literature 2, by blocking a part of the ventilation passage by a protruding portion to impede flow of the air in the ventilation passage, it is possible to reduce aerodynamic sound generated while the railway vehicle is travelling. Furthermore, since the brake disc and the aerodynamic-sound reduction member are separate components, the protruding portion of the aerodynamic-sound reduction member do not affect the rigidity of the brake disc. Accordingly, it is possible to prevent a warpage resulting from the protruding portion to occur in the brake disc.

In Patent Literature 2, since the brake disc and the aerodynamic-sound reduction member are separate components, it is possible to ensure a high degree of design freedom for the brake disc. Furthermore, the aerodynamic-sound reduction member may not be a cause of a decrease in yield of the brake disc.

As in Patent Literature 2, Patent Literature 3 also proposes a technique of providing a member for reducing aerodynamic sound for the disc brake device separately from the brake disc.

### CITATION LIST

### Patent Literature

Patent Literature 1: Japanese Patent Application Publication No. 2007-205428

Patent Literature 2: International Application Publication No. 2019/194203

Patent Literature 3: Japanese Patent Application Publication No. 2021-81034

### SUMMARY OF INVENTION

### Technical Problem

In Patent Literature 1, the connecting portion for reducing aerodynamic sound is formed integrally with the brake disc body and the fins. The flow rate of air in the ventilation passage is restricted by the size of a clearance between the connecting portion and the wheel. However, it is difficult to form the connecting portion that is integral with the disc body and the fins in a dimensionally accurate manner. For example, if the clearance between the connecting portion and the wheel is smaller, the cooling performance of the brake disc may be lowered. To ensure the cooling performance of the brake disc, it is necessary to strictly control dimensions of the clearance between the connecting portion and the wheel, in other words, a height of the connecting portion.

In Patent Literatures 2 and 3, the protruding portion for reducing aerodynamic sound is included in a member that is separate from brake disc, and it is possible to form the protruding portion in a dimensionally accurate manner. However, the protruding portion is arranged between a rotary member such as the wheel and the disc body. Generally, the production tolerance for the distance from the rotary member to the disc body, namely, the height of each fin is relatively large. Accordingly, it is difficult to accurately adjust the clearance between the protruding portion and the disc body. To ensure the cooling performance of the brake disc, it is necessary to increase the accuracy of the size of the clearance between the protruding portion and the disc body.

Furthermore, in Patent Literatures 2 and 3, a plurality of fins are formed in a radial formation on a surface (back surface) on a wheel side of the disc body. To prevent each fin from interfering with the protruding portion, it is necessary to divide the protruding portion in the circumferential direction of the disc body as in Patent Literature 2, or to provide a recess in the fin as in Patent Literature 3. In this case, production steps of the disc brake device increase.

An objective of the present disclosure is to provide a disc brake device for a railway vehicle, which facilitates control of the clearance between the protruding portion for reducing aerodynamic sound and the brake disc and which is easy to produce.

### Solution to Problem

A disc brake device according to the present disclosure is a disc brake device for a railway vehicle. The disc brake device includes a rotary member, a brake disc, and an airflow-rate restriction member. The rotary member is attached to an axle of the railway vehicle. The brake disc includes an annular disc body and a plurality of fins. The disc body has a back surface that faces the rotary member. The plurality of fins are arranged in a radial formation on the back surface. The plurality of fins each extend in a radial direction of the disc body. The airflow-rate restriction member is for restricting airflow rate between the rotary member and the disc body. The airflow-rate restriction member includes a base plate and a protruding portion. The base plate is sandwiched between the rotary member and the fins. The protruding portion is arranged inward in the radial direction with respect to the fins. The protruding portion protrudes from the base plate toward a disc body side. The protruding portion extends in a circumferential direction of the disc body.

### Advantageous Effects of Invention

The disc brake device for a railway vehicle according to the present disclosure facilitates control of the clearance between the protruding portion for reducing aerodynamic sound and the brake disc and is easy to produce.

### BRIEF DESCRIPTION OF DRAWINGS

FIG. 1 is a longitudinal sectional view illustrating a schematic configuration of a disc brake device for a railway vehicle according to a first embodiment.

FIG. 2 is a back surface view of the brake disc included in the disc brake device illustrated in FIG. 1.

FIG. 3 is a partial enlarged view of the disc brake device illustrated in FIG. 1.

FIG. 4 is a partial longitudinal sectional view of a disc brake device for a railway vehicle according to a second embodiment.

FIG. 5 is a partial longitudinal sectional view of a disc brake device according to a variation of the first embodiment.

FIG. 6 is a partial longitudinal sectional view of a disc brake device according to a variation of the first embodiment.

FIG. 7 is a graph illustrating results of tests conducted by using a model of the disc brake device according to the first embodiment.

FIG. 8 is a further graph illustrating results of tests conducted by using a model of the disc brake device according to the first embodiment.

FIG. 9 is a still further graph illustrating results of tests conducted by using a model of the disc brake device according to the first embodiment.

### DESCRIPTION OF EMBODIMENTS

The disc brake device according to embodiments is a disc brake device for a railway vehicle. The disc brake device includes a rotary member, a brake disc, and an airflow-rate restriction member. The rotary member is attached to an axle of the railway vehicle. The brake disc includes an annular disc body and a plurality of fins. The disc body has a back surface that faces the rotary member. The plurality of fins are arranged in a radial formation on the back surface. The plurality of fins each extend in a radial direction of the disc body. The airflow-rate restriction member is for restricting airflow rate between the rotary member and the disc body. The airflow-rate restriction member includes a base plate and a protruding portion. The base plate is sandwiched between the rotary member and the fins. The protruding portion is arranged inward in the radial direction with respect to the fins. The protruding portion protrudes from the base plate toward a disc body side. The protruding portion extends in a circumferential direction of the disc body (First configuration).

In the disc brake device according to the first configuration, airflow rate between the rotary member and the disc body is restricted by the airflow-rate restriction member that is separate from the brake disc. More specifically, the amount of air passing between the rotary member and the disc body is restricted by the protruding portion provided on the airflow-rate restriction member, reducing aerodynamic sound. The protruding portion is arranged inward in the radial direction with respect to the plurality of fins provided on the back surface of the disc body. Accordingly, control of the clearance between the brake disc and the protruding portion is facilitated. Furthermore, since the protruding portion is arranged on the inner circumferential side with respect to the fins, it is neither necessary to divide the protruding portion in the circumferential direction of the disc body to avoid interfering with the fins, nor to provide a recess in each fin for arranging the protruding portion. Accordingly, it is possible to simplify production steps of the brake disc.

The disc brake device according to the first configuration therefore facilitates control of the clearance between the protruding portion for reducing aerodynamic sound and the brake disc and is easy to produce.

The protruding portion may include a curved surface. The curved surface is arranged, for example, in a portion of a surface of the protruding portion on the brake disc side. The curved surface may have an arc-shape that is convex outward of the protruding portion, when the disc brake device is viewed in section that includes a central axis of the disc body (Second configuration).

According to the second configuration, the protruding portion of the airflow-rate restriction member includes the curved surface on the surface thereof. The curved surface has an arc-shape that is convex outward of the protruding portion, when the disc brake device is viewed in section that includes the central axis of the disc body. The curved surface allows air to be smoothly guided between the rotary member and the disc body while the railway vehicle is travelling. Accordingly, the airflow rate between the rotary member and the disc body does not decrease significantly, and it is possible to maintain good cooling performance of the brake disc.

The curved surface may have a radius of curvature of 10 mm or more (Third configuration).

In the third configuration, the radius of curvature of the curved surface is 10 mm or more. This makes it possible to ensure the cooling performance of the brake disc and reduce the aerodynamic sound, both of which are achieved in a well-balanced way.

The protruding height of the protruding portion may be no more than a height of the fins. In this case, the length of the clearance between the protruding portion and the fins along the radial direction may be less than 10 mm (Fourth configuration). The protruding height of the protruding portion may be larger than the height of the fins. In this case, the length of the clearance between the protruding portion and the disc body along the radial direction may be less than 10 mm (Fifth configuration).

In the fourth and fifth configurations, the length of the clearance between the protruding portion of the airflow-rate restriction member and the fins or the disc body is less than 10 mm. This makes it possible to appropriately restrict the airflow rate between the rotary member and the disc body, and to reduce the aerodynamic sound more effectively.

Embodiments of the present disclosure will now be described with reference to drawings. In the figures, similar or equivalent configurations will have the same reference signs and the description will not be repeated again.

### First Embodiment

### [Configuration of Disc Brake Device]

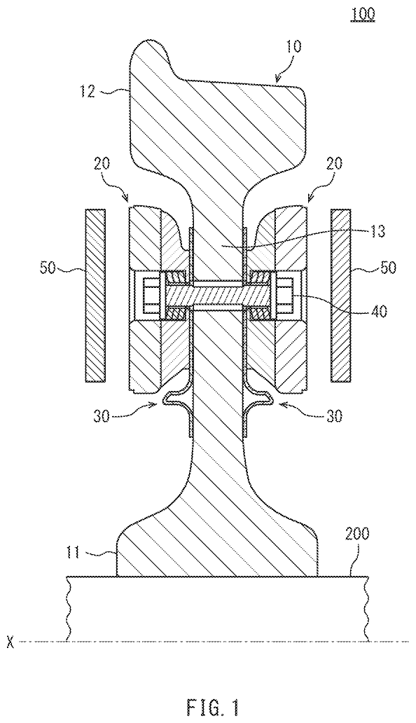

FIG. 1 is a longitudinal sectional view illustrating a schematic configuration of a disc brake device 100 for a railway vehicle according to the first embodiment. The longitudinal section refers to a section taken by cutting the disc brake device 100 in a plane that includes a central axis X. The central axis X is an axial centerline of an axle 200 of the railway vehicle. The direction in which the central axis X extends is hereinafter referred to as an axial direction.

As illustrated in FIG. 1, the disc brake device 100 includes a rotary member 10, a brake disc 20, and an airflow-rate restriction member 30.

The rotary member 10 is attached to the axle 200 and rotates about the central axis X integrally with the axle 200. In the example of the embodiment, the rotary member 10 is a wheel of the railway vehicle. However, the rotary member 10 may be any other disc-like body, instead of the wheel. In the example of FIG. 1, the rotary member 10 includes a boss portion 11, a rim portion 12, and a plate portion 13. An axle 200 is inserted in the boss portion 11. The rim portion 12 constitutes an outer circumferential portion of the wheel. The plate portion 13 connects the boss portion 11 and the rim portion 12.

The brake disc 20 is arranged on the rotary member 10, one for each of opposite sides of the rotary member 10 in the axial direction. Each brake disc 20 is fastened to the plate portion 13 of the rotary member 10, for example, by a fastening member 40, which is made up of a bolt and a nut. A brake lining 50 is arranged outward in the axial direction of each brake disc 20. The airflow-rate restriction member 30 is arranged between the rotary member 10 and each brake disc 20.

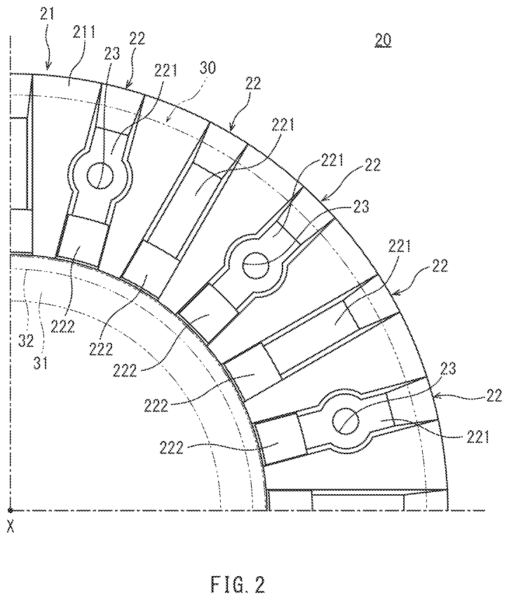

FIG. 2 is a view when the brake disc 20 is viewed from the side of the rotary member 10 (back surface view). FIG. 2 illustrates a quadrant portion of the brake disc 20. In FIG. 2, in addition to the brake disc 20, the airflow-rate restriction member 30 is illustrated by a phantom line.

With reference to FIG. 2, the brake disc 20 includes a disc body 21 and a plurality of fins 22.

The disc body 21 has an annular shape. More specifically, the disc body 21 has a circular plate shape, with the central axis X being the axial centerline. The circumferential direction and the radial direction of the disc body 21 is hereinafter referred to simply as a circumferential direction and a radial direction.

The disc body 21 includes a back surface 211. The back surface 211 is a surface provided on one side of the disc body 21 in the axial direction. The back surface 211 faces the rotary member 10 (FIG. 1). A sliding surface is provided on the other side of the disc body 21 in the axial direction. The brake lining 50 (FIG. 1) is to be pressed against the sliding surface to generate a braking force.

The plurality of fins 22 are arranged in a radial formation on the back surface 211 of the disc body 21. The fins 22 each extend in the radial direction. Each fin 22 protrudes from the back surface 211 to the side of the rotary member 10 (FIG. 1). In this way, spaces are formed, which are surrounded by the rotary member 10, fins 22 that are adjacent in the circumferential direction, and the disc body 21. These spaces serve as ventilation passages through which air passes when the brake disc 20 rotates with the rotary member 10.

Each of the fins 22 includes a top surface 221 and an inner circumferential surface 222. The top surface 221 is a surface that is arranged on each fin 22 on the side of the rotary member 10 (FIG. 1). The top surface 221 extends in the radial direction. The inner circumferential surface 222 is an end face that is arranged inward in the radial direction on each fin 22. The inner circumferential surface 222 is continuous with the top surface 221. The inner circumferential surface 222 extends from the top surface 221 to the back surface 211 of the disc body 21.

A fastening hole 23 or a key groove (not illustrated) may be formed on each fin 22. The fastening hole 23 passes through the fin 22 and the disc body 21. The fastening member 40 (FIG. 1) is to be inserted in the fastening hole 23. The key groove is formed on the top surface 221 of the fin 22. A key (not illustrated) is to be fit into the key groove to restrain relative rotation between the brake disc 20 and the rotary member 10 (FIG. 1). The number of fastening holes 23 and the key grooves can be determined as appropriate. In the brake disc 20, the fastening hole 23 or the key groove may be formed on all fins 22, or there may be any fin 22 on which no fastening hole 23 or key groove is formed.

The airflow-rate restriction member 30 is a member that is separate from the brake disc 20, and is a member that is independent from the brake disc 20. The airflow-rate restriction member 30 includes a base plate 31 and a protruding portion 32.

The base plate 31 has an annular shape, for example. In the example of the embodiment, the base plate 31 has a substantially circular shape. The base plate 31 is arranged substantially coaxially with the disc body 21.

The protruding portion 32 is arranged inward in the radial direction with respect to the plurality of fins 22 of the brake disc 20. The protruding portion 32 protrudes from the base plate 31 toward the disc body 21 side. The protruding portion 32 extends in the circumferential direction. In the example of the embodiment, the protruding portion 32 extends around the entire circumference of the base plate 31. In other words, the protruding portion 32 has a substantially circular shape as with the base plate 31.

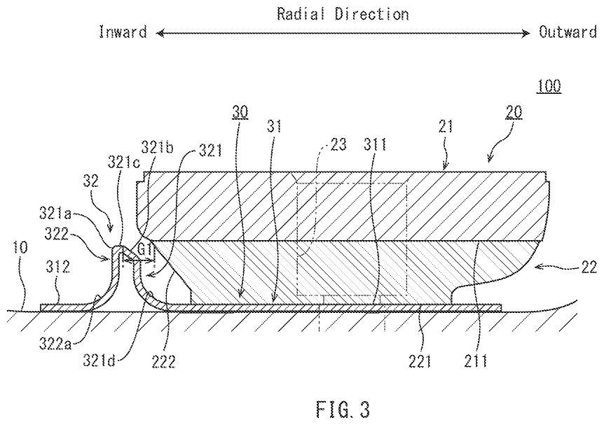

FIG. 3 is a partial enlarged view of the disc brake device 100 illustrated in FIG. 1. The configuration of the airflow-rate restriction member 30 will now be described in detail with reference to FIG. 3. For simplification of the drawing, the fastening member 40 is omitted in FIG. 3.

With reference to FIG. 3, the base plate 31 of the airflow-rate restriction member 30 is sandwiched between the rotary member 10 and the plurality of fins 22 provided on the brake disc 20. An outer circumferential portion 311 of the base plate 31 is in contact with the top surface 221 of each fin 22. The outer circumferential portion 311 is a portion of the base plate 31 located outward in the radial direction with respect to the protruding portion 32.

In a longitudinal sectional view of the disc brake device 100, the outer circumferential portion 311 of the base plate 31 extends in the radial direction. From the protruding portion 32, the outer circumferential portion 311 extends outward beyond the fastening hole 23, for example. The outer circumferential portion 311 may extend up to an outer end of the top surface 221 of the fin 22 in the radial direction or may extend beyond the end. The length of the outer circumferential portion 311 along the radial direction is not particularly limited and can be determined as appropriate.

In addition to the outer circumferential portion 311, the base plate 31 includes an inner circumferential portion 312. The inner circumferential portion 312 is a portion of the base plate 31 located inward in the radial direction with respect to the protruding portion 32. In a longitudinal sectional view of the disc brake device 100, the inner circumferential portion 312 is shorter than the outer circumferential portion 311, for example. The length of the inner circumferential portion 312 along the radial direction can be determined as appropriate.

In the example of the embodiment, the inner circumferential surface 222 of each fin 22 has a shape such that the end on the disc body 21 side is located inward in the radial direction from the end on the top surface 221 side. The protruding portion 32 is arranged inward in the radial direction from the inner circumferential surface 222 of the fin 22 to avoid interfering with the fin 22. The protruding portion 32 includes an outer circumferential surface 321 and an inner circumferential surface 322. The inner circumferential surface 322 is a portion of a surface of the protruding portion 32, which faces inward in the radial direction. The outer circumferential surface 321 is any other portion of a surface of the protruding portion 32 than the inner circumferential surface 322.

The outer circumferential surface 321 includes curved surfaces 321a, 321b. In a longitudinal sectional view of the disc brake device 100, the curved surfaces 321a, 321b each have an arc-shape that is convex toward the outside of the protruding portion 32. The curved surfaces 321a, 321b are arranged on top of the protruding portion 32. The curved surface 321a is arranged in a portion of outer circumferential surface 321 which is adjacent to the inner circumferential surface 322. The curved surface 321b is arranged outward in the radial direction with respect to the curved surface 321a. The curved surface 321b is connected to the curved surface 321a, for example, via a portion 321c that is linear in a longitudinal sectional view of the disc brake device 100.

As described above, the curved surface 321b has an arc-shape that is convex outward of the protruding portion 32 in a longitudinal sectional view of the disc brake device 100. In the embodiment, the curved surface 321b has an arc-shape that is convex toward the fin 22 side in a longitudinal sectional view of the disc brake device 100. The curved surface 321b is provided on the protruding portion 32, for example, so as to face the inner circumferential surface 222 of the fin 22. The radius of curvature of the curved surface 321b is preferably 10 mm or more.

The outer circumferential surface 321 may further include a curved surface 321d. Similarly, the inner circumferential surface 322 may include a curved surface 322a. The curved surfaces 321d, 322a are arranged at the base of the protruding portion 32. The curved surfaces 321d, 322a may have an arc-shape that is concave inward of the protruding portion 32 in a longitudinal sectional view of the disc brake device 100.

There is a clearance G1 between the protruding portion 32 and the fin 22. The length of the clearance G1 along the radial direction is preferably less than 10 mm and is more preferably 7 mm or less. The length of the clearance G1 refers to the distance along the radial direction from the protruding portion 32 to the fin 22 in a longitudinal sectional view of the disc brake device 100. The length of the clearance G1 can be, for example, the distance along the radial direction from a radius curve end inward of the curved surface 321b of the protruding portion 32 in the radial direction (linear portion 321c side) to the inner circumferential surface 222 of the fin 22. In other words, in a longitudinal sectional view of the disc brake device 100, the length of the clearance G1 can be the distance along the radial direction from an apex of the protruding portion 32 to the fin 22.

The airflow-rate restriction member 30 can be formed, for example, from a metal plate. The metal plate preferably has a plate thickness of 1.0 mm or more and 3.0 mm or less. The airflow-rate restriction member 30 is shaped by subjecting the metal plate to press forming, for example. In this case, the base plate 31 and the protruding portion 32 are integrally formed. However, the protruding portion 32 may be fixed to the base plate 31 by welding or the like after the base plate 31 and the protruding portion 32 are separately formed.

### [Advantageous Effects]

In the disc brake device 100 according to the embodiment, with the airflow-rate restriction member 30 that is separate from the brake disc 20, airflow rate between the rotary member 10 and the disc body 21 is restricted. More specifically, the protruding portion 32 provided on the airflow-rate restriction member 30 partially blocks an opening of the ventilation passage defined by the rotary member 10, the disc body 21, and the fins 22. Accordingly, the airflow rate in the ventilation passage can be restricted and the aerodynamic sound generated while the railway vehicle is travelling can be reduced.

If the protruding portion 32 of the airflow-rate restriction member 30 were to be arranged between the rotary member 10 and the disc body 21, it would be necessary to strictly control the clearance between the protruding portion 32 and the disc body 21 to accurately ensure the clearance to obtain a predetermined cooling performance for the brake disc 20. However, in the disc brake device 100 according to the embodiment, the protruding portion 32 of the airflow-rate restriction member 30 is not arranged between the rotary member 10 and the disc body 21. The protruding portion 32 is arranged inward in the radial direction with respect to the plurality of fins 22. Accordingly, during production of the disc brake device 100, it is not necessary to strictly control the clearance between the protruding portion 32 and the brake disc 20. Furthermore, it is neither necessary to divide the protruding portion 32 in the circumferential direction to avoid interfering with the fins 22, nor to provide a recess in each fin 22 for arranging the protruding portion 32. Accordingly, it is possible to simplify production steps of the brake disc 20.

In this way, the disc brake device 100 according to the embodiment facilitates control of the clearance between the protruding portion 32 for reducing aerodynamic sound and the brake disc 20 and can be produced easily.

In the embodiment, the surface of the protruding portion 32 of the airflow-rate restriction member 30 includes the curved surface 321b. In a longitudinal sectional view of the disc brake device 100, the curved surface 321b has an arc-shape that is convex toward the fin 22 side. The curved surface 321b allows air to be smoothly guided into the ventilation passage while the railway vehicle is travelling. Accordingly, the airflow rate in the ventilation passage does not decrease significantly and it is possible to maintain good cooling performance of the brake disc 20.

The curved surface 321b of the protruding portion 32 preferably has a radius of curvature of 10 mm or more. Accordingly, it is possible to ensure the cooling performance of the brake disc 20 and reduce the aerodynamic sound, both of which are achieved in a well-balanced way.

In the disc brake device 100 according to the embodiment, there is the clearance G1 between the protruding portion 32 of the airflow-rate restriction member 30 and the fins 22 of the brake disc 20. The length of the clearance G1 along the radial direction is preferably less than 10 mm. In this case, air entering the ventilation passage can appropriately be restricted and it is possible to reduce the aerodynamic sound more effectively.

### Second Embodiment

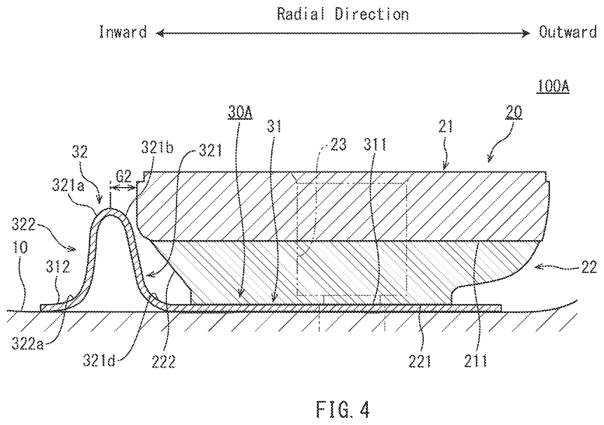

FIG. 4 is a partial longitudinal sectional view of a disc brake device for a railway vehicle 100A according to the second embodiment. The disc brake device 100A according to the present embodiment has substantially the same configuration as the disc brake device 100 according to the first embodiment. However, the disc brake device 100A is different from the disc brake device 100 according to first embodiment in terms of the configuration of the airflow-rate restriction member 30A.

In the disc brake device 100 according to the first embodiment, the protruding height of the protruding portion 32 of the airflow-rate restriction member 30 is no more than the height of the fin 22 (FIG. 3). On the other hand, as illustrated in FIG. 4, in the disc brake device 100A according to the embodiment, the protruding height of the protruding portion 32 of the airflow-rate restriction member 30A is larger than the height of the fin 22. The height of the fin 22 refers to the distance along the axial direction from the top surface 221 of the fin 22 to the back surface 211 of the disc body 21. The protruding height of the protruding portion 32 refers to the distance along the axial direction from a surface on the side of the fin 22 of the outer circumferential portion 311 of the base plate 31 to an apex of the protruding portion 32.

In a longitudinal sectional view of the disc brake device 100A, the protruding portion 32 protrudes from the base plate 31 to a position reaching the disc body 21 in the axial direction. There is a clearance G2 between the protruding portion 32 and the disc body 21. The length of the clearance G2 along the radial direction is preferably less than 10 mm, and is more preferably 7 mm or less. The length of the clearance G2 refers to the distance along the radial direction from the protruding portion 32 to the disc body 21 in a longitudinal sectional view of the disc brake device 100A. The length of the clearance G2 can be the distance along the radial direction from an apex of the protruding portion 32 up to the disc body 21 in a longitudinal sectional view of the disc brake device 100A.

As with the first embodiment, the protruding portion 32 is arranged slightly away from the brake disc 20 such that air can be introduced into the ventilation passage defined by the rotary member 10, the disc body 21, and fins 22. The protruding portion 32 can restrict the airflow rate of the ventilation passage and reduce the aerodynamic sound. As with the first embodiment, the disc brake device 100A according to the present embodiment can also facilitate control of the clearance between protruding portion 32 and the brake disc 20, and can achieve simplification of the production steps. Furthermore, by making the length of the clearance G2 between the protruding portion 32 and the disc body 21 in the radial direction less than 10 mm, air entering the ventilation passage can appropriately be restricted and it is possible to reduce the aerodynamic sound more effectively.

Although embodiments according to the present disclosure have been described above, the present disclosure is not limited to the embodiments and various alterations may be made thereto without departing from the gist thereof.

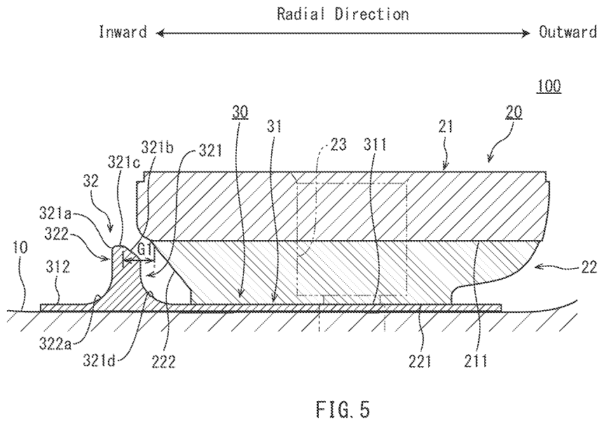

In the first embodiment, the protruding portion 32 of the airflow-rate restriction member 30 is hollow in a longitudinal sectional view of the disc brake device 100. However, as illustrated in FIG. 5, the protruding portion 32 may be solid in a longitudinal sectional view of the disc brake device 100. Similarly, in the second embodiment, the protruding portion 32 of the airflow-rate restriction member 30A can also be solid in a longitudinal sectional view of the disc brake device 100A. In these cases, the protruding portion 32 may also be formed integrally with the base plate 31, or formed separately from the base plate 31.

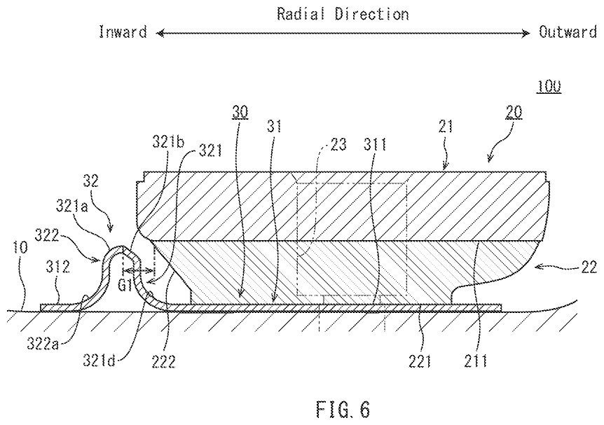

In the first embodiment, the inner circumferential surface 322 of the protruding portion 32 of the airflow-rate restriction member 30 is entirely linear in a longitudinal sectional view of the disc brake device 100. That is, in the protruding portion 32, the radius of curvature of the curved surface 321a that is continuous with the inner circumferential surface 322 is significantly small as compared with the radius of curvature of the curved surface 321b on the side of the disc body 21. However, as illustrated in FIG. 6, as with the airflow-rate restriction member 30A according to the second embodiment, it is possible to extend the radius of curvature of the curved surface 321a on the side of the inner circumferential surface 322 to make part or all of the inner circumferential surface 322 the curved surface. On the other hand, in the airflow-rate restriction member 30A of the second embodiment, the inner circumferential surface 322 of the protruding portion 32 may be entirely linear in a longitudinal sectional view of the disc brake device 100A.

In the embodiments, each protruding portion 32 of the airflow-rate restriction members 30, 30A includes curved surfaces 321a, 321b, 321d, 322a on its surface. However, the surface of the protruding portion 32 may not include part or all of curved surfaces 321a, 321b, 321d, 322a. The protruding portion 32 may have, for example, a triangular or quadrangular shape in a longitudinal sectional view of disc brake device 100 or 100A. The shape of the protruding portion 32 is not limited to the examples of the embodiments.

In the embodiments, the airflow-rate restriction members 30, 30A have an annular shape. However, the airflow-rate restriction members 30, 30A may not necessarily have a continuous annular shape. The airflow-rate restriction members 30, 30A may each be divided into pieces in the circumferential direction. The airflow-rate restriction members 30, 30A may each be divided, for example, in two or in four. Furthermore, the airflow-rate restriction members 30, 30A may not necessarily be provided around the entire circumference of the brake disc 20.

### EXAMPLE

The present disclosure will now be described in detail through the use of Example. However, the present disclosure is not limited to Example described below.

To confirm advantageous effects of the disc brake device according to the present disclosure, tests by using a model of the brake disc 20 and the airflow-rate restriction member 30 of the first embodiment were conducted. In these tests, a model of a 15-degrees equivalent portion cut from the brake disc 20 and the airflow-rate restriction member 30 was created by using a 3D printer. A commercially available suction machine was used to cause air to flow from the inner circumferential side toward the outer circumferential side of the model. The sound pressure level and the airflow velocity generated when the air is caused to flow were measured by using a commercially available precision sound-level meter and a hot-wire anemometer, respectively. The larger sound pressure level means a larger noise (aerodynamic sound), and the larger airflow velocity means higher cooling performance of the brake disc 20.

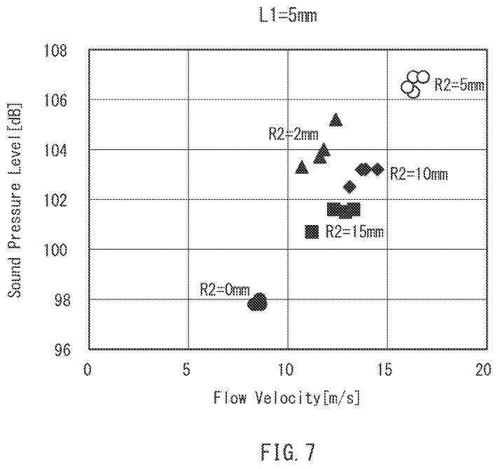

In these tests, the sound pressure level and the airflow velocity were observed while changing a radius of curvature R1 of the curved surface 321a of the protruding portion 32 of the airflow-rate restriction member 30, a radius of curvature R2 of the curved surface 321b, and a length L1 of the clearance G1 along the radial direction between the protruding portion 32 and the fins 22. The test results are illustrated in FIGS. 7 to 9.

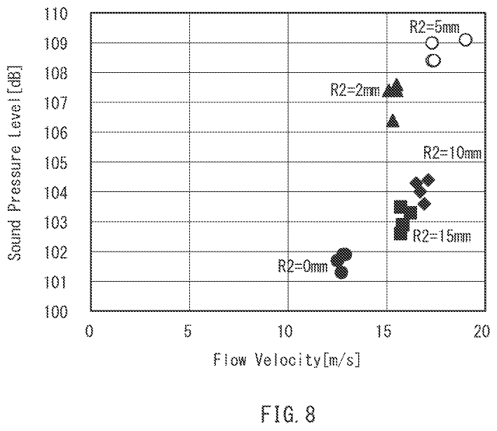

With reference to FIGS. 7 and 8, when the length L1 of the clearance G1 was 5 mm or 7 mm, strong effects of the radius of curvature R2 of the curved surface 321b on the sound pressure level and the airflow velocity were evident. As illustrated in FIGS. 7 and 8, when the radius of curvature R2 of the curved surface 321b was 0 mm (right angle), the sound pressure level decreased, while the airflow velocity was small, resulting in a relatively low cooling performance of the brake disc 20. When the radius of curvature R2 of the curved surface 321b was 2 mm or 5 mm, the airflow velocity was ensured and the cooling performance of the brake disc 20 was higher, while the sound pressure level relatively increased. When the radius of curvature R2 was 5 mm, the sound pressure level was larger as compared to the case in which the radius of curvature R2 was 2 mm. When the radius of curvature R2 of the curved surface 321b was 10 mm or 15 mm, the airflow velocity was at a similar level to the case in which the radius of curvature R2 was 2 mm and the cooling performance of the brake disc 20 was ensured, while the sound pressure level decreased as compared to the case in which the radius of curvature R2 was 2 mm. In other words, it has been confirmed that when the radius of curvature R2 of the curved surface 321b is 10 mm or more, the cooling performance of the brake disc 20 can be ensured and the noise can be reduced, both of which are achieved in a well-balanced way.

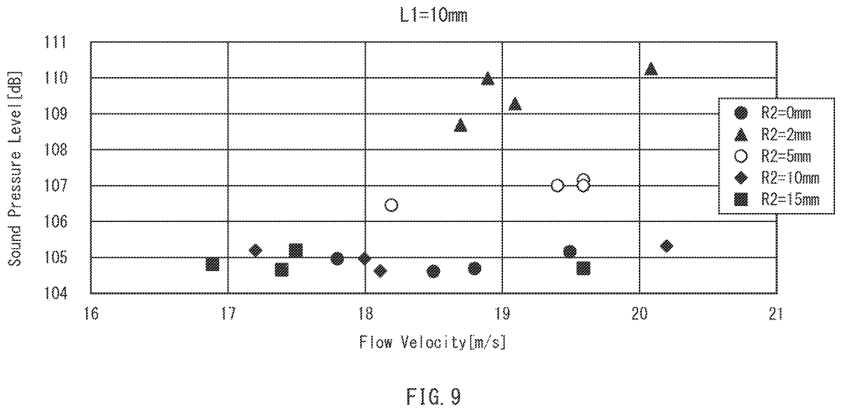

With reference to FIG. 9, when the length L1 of the clearance G1 was 10 mm, almost no effect of the radius of curvature R2 of the curved surface 321b on the sound pressure level and the airflow velocity was evident. When the length L1 of the clearance G1 was 10 mm, the change in the sound pressure level and the airflow velocity was insignificant even when the radius of curvature R2 of the curved surface 321b was changed. Accordingly, to produce effects of making the radius of curvature R2 of the curved surface 321b 10 mm or more, it is considered that the length L1 of the clearance G1 is preferably less than 10 mm.

Note that, in these tests, the radius of curvature R1 of the curved surface 321a was changed from 0 mm (right angle) to 2 mm, 4 mm, and 5 mm, the radius of curvature R1 had less effect on the sound pressure level and the airflow velocity.

### REFERENCE SIGNS LIST

100, 100A: Disc brake device
10: Rotary member
20: Brake disc
21: Disc body
211: Back surface
22: Fin
30, 30A: Airflow-rate restriction member
31: Base plate
32: Protruding portion
321b: Curved surface

1. A disc brake device for a railway vehicle, the disc brake device comprising:
a rotary member attached to an axle of the railway vehicle;
a brake disc including an annular disc body having a back surface that faces the rotary member and a plurality of fins arranged in a radial formation on the back surface, the fins each extending in a radial direction of the disc body; and
an airflow-rate restriction member for restricting airflow rate between the rotary member and the disc body, wherein
the airflow-rate restriction member includes:
a base plate sandwiched between the rotary member and the fins; and
a protruding portion arranged inward in the radial direction with respect to the fins, the protruding portion protruding from the base plate toward a disc body side, the protruding portion extending in a circumferential direction of the disc body.

2. The disc brake device according to claim 1, wherein
the protruding portion includes a curved surface arranged in a portion of a surface of the protruding portion on a brake disc side, the curved surface having an arc-shape that is convex outward of the protruding portion when the disc brake device is viewed in section that includes a central axis of the disc body.

3. The disc brake device according to claim 2, wherein
the curved surface has a radius of curvature of 10 mm or more.

4. The disc brake device according to claim 1, wherein
a protruding height of the protruding portion is no more than a height of the fins, and
a length of a clearance between the protruding portion and the fins along the radial direction is less than 10 mm.

5. The disc brake device according to claim 1, wherein
a protruding height of the protruding portion is larger than a height of the fins, and
a length of a clearance between the protruding portion and the disc body along the radial direction is less than 10 mm.

6. The disc brake device according to claim 2, wherein
a protruding height of the protruding portion is no more than a height of the fins, and
a length of a clearance between the protruding portion and the fins along the radial direction is less than 10 mm.

7. The disc brake device according to claim 3, wherein
a protruding height of the protruding portion is no more than a height of the fins, and
a length of a clearance between the protruding portion and the fins along the radial direction is less than 10 mm.

8. The disc brake device according to claim 2, wherein
a protruding height of the protruding portion is larger than a height of the fins, and
a length of a clearance between the protruding portion and the disc body along the radial direction is less than 10 mm.

9. The disc brake device according to claim 3, wherein
a protruding height of the protruding portion is larger than a height of the fins, and
a length of a clearance between the protruding portion and the disc body along the radial direction is less than 10 mm.
